(19) United States
(12) Patent Application Publication
(10) Pub. No.: US 2020/0329634 A1
(43) Pub. Date: Oct. 22, 2020

(54) METHOD AND APPARATUS FOR DELIVERY OF BULK DRY NUTRIENTS AND LIQUIDS TO MATURE ROW CROPS

(71) Applicant: Vandy Mill, LLC, Greensburg, IN (US)

(72) Inventor: Dirk J. RICKE, Greensburg, IN (US)

(21) Appl. No.: 16/919,321

(22) Filed: Jul. 2, 2020

Related U.S. Application Data
(63) Continuation-in-part of application No. 16/239,056, filed on Jan. 3, 2019.
(60) Provisional application No. 62/613,224, filed on Jan. 3, 2018.

(51) Int. Cl. A01C 23/04; A01C 15/00; A01C 23/00; A01C 21/00

(52) U.S. Cl. CPC A01C 23/047; A01C 21/007; A01C 23/007; A01C 15/00

(57) ABSTRACT

A nutrient distributor in accordance with the present disclosure includes a vehicle with a frame, a prime mover, and a distribution system. The distribution system conveys dry nutrients to rowed crops.

### PRIORITY CLAIM

This application is a continuation-in-part of U.S. application Ser. No. 16/239,056, filed Jan. 3, 2019, which claims priority under 35 U.S.C. § 119(e) to U.S. Provisional Application Ser. No. 62/613,224, filed Jan. 3, 2018, each of which is expressly incorporated by reference herein.

### BACKGROUND

The present disclosure relates to the devices for distributing nutrients. More specifically, the present disclosure relates to device that is configured to distribute nutrients to mature, row crops.

Nutrients for row crops may be in dry or liquid form. Liquid nutrients have a tendency to evaporate or degrade if they are applied to crops too far in advance of a rainfall. Dry nutrients, on the other hand, have a larger window for application before a rainfall is needed to wash the nutrients into the soil surrounding the row crops. Applying dry nutrients in bulk quantities to relatively mature row crops is difficult over large areas due to the structure of the plant. Traditional broadcast spreading on mature crops results in dry nutrients landing on plant foliage, reducing the ability of the plant roots to absorb the nutrients.

### SUMMARY

The present row-wise delivery discloses one or more of the features recited in the appended claims and/or the following features which, alone or in any combination, may comprise patentable subject matter:

According to one aspect of the present disclosure, a vehicle for distributing nutrients comprises a frame, an engine coupled to the frame, and a distribution system. The distribution system is configured to distribute nutrients directly to the root structure of a mature row crop and a crop-yield increasing liquid to the leaves of the mature row crop at the same time.

In illustrative embodiments, the distribution system includes a dry-bulk nutrient delivery system and a liquid delivery system. The dry-bulk nutrient delivery system may include a nutrient release system and a diffusion system. The nutrient release system is configured to convey dry-bulk nutrients from the vehicle to the diffusion system. the diffusion system coupled to the nutrient release system and configured to apply the nutrients directly on a root structure of the mature row crop.

In illustrative embodiments, the liquid delivery system includes a liquid container coupled to the vehicle, a liquid-conveyor duct coupled to the liquid container, and a plurality of spray nozzles coupled to the liquid-conveyor duct. The plurality of spray nozzles are configured to discharge the crop-yield increasing liquid onto the leaves of the mature row crop simultaneously with delivery of the dry-bulk nutrients to the root structure of the mature row crop.

In illustrative embodiments, the diffusion system includes a manifold coupled to a plenum and in fluid communication with a plurality of ducts, a boom coupled to the frame of the vehicle and configured to support the plurality of ducts, and a plurality of drop ducts coupled to the boom, each drop duct being in fluid communication with one of the plurality of conveyor ducts to deliver the nutrients from the manifold to each of the drop ducts.

In illustrative embodiments, the boom includes a support structure coupled to the frame for pivotable movement about an axis, a duct carriage coupled to the support structure, and a toolbar coupled to the support structure and configured to move upward and downward relative to the frame as the support structure pivots about the axis.

In illustrative embodiments, the feed system includes a metering unit that is configured to regulate an output of dry nutrients. The metering unit includes a first auger and a second auger interlocked with the first auger, the first auger is mounted to the feed system for rotation and the second auger mounted to the feed system for rotation opposite the first auger.

In illustrative embodiments, the distribution system further includes a blower coupled to the manifold of the feed system. The blower is configured to move the nutrients from the manifold to the diffusion system.

In illustrative embodiments, the diffusion system includes a manifold, a toolbar kit coupled to the frame of the vehicle, and a plurality of diffusers coupled to the toolbar. The manifold includes a plenum and a plurality of ducts coupled to the plenum and arranged to extend from the plenum to the toolbar kit.

In illustrative embodiments, the toolbar kit includes a support structure coupled to the frame for pivotable movement about a support structure axis, a duct carriage coupled to the support structure, and a toolbar coupled to the support structure and configured to move upward and downward relative to the frame as the support structure pivots about the support structure axis. The duct carriage is coupled to the support structure for pivotable movement as the toolbar is moved upwardly and downwardly and includes a first duct carrier configured to receive a first set of ducts and a second carrier configured to receive a second set of ducts.

In illustrative embodiments, the toolbar includes a plurality of arms spaced apart from one another along a length of the toolbar and at least one diffuser is coupled to each arm. Each diffuser includes a body, an outlet chamber coupled to the body, and an overflow chamber coupled to the body.

In illustrative embodiments, the outlet chamber includes a first port extending from the body in a first direction and a second port extending from the body in a second direction opposite the first direction. The first port is configured to direct nutrients to a first row of plants and the second port is configured to direct nutrients to a second row of plants spaced apart from the first row of plants. The overflow chamber includes a first overflow port extending from the body in the first direction and a second overflow port extending from the body in the second direction opposite the first direction.

In illustrative embodiments, the apparatus further includes a control system configured to vary an output of nutrients released at the root structure of the mature crops over a geographic area based on predetermined conditions. The control system includes memory and a processor, the memory is configured to store data associated with the predetermined conditions and the processor is configured to send input signals to the nutrient release system to vary an output of nutrients over a specific geographic area based on the predetermined conditions.

In illustrative embodiments, the control system is configured to release a first output of nutrients over a first geographic area and is configured to release a second output of nutrients over a second geographic area based on the predetermined conditions. The predetermined conditions include at least one of soil type, ground fertility, rain maps, nitrogen models, tile maps, and normalized difference vegetation index. The control system is configured to compare historical conditions to the predetermined conditions to calibrate the output of nutrients. The dry nutrients include nitrogen.

According to another aspect of the present disclosure, a method includes providing a vehicle having a container of dry nutrients and a liquid container. The method further includes moving the vehicle through the field of row crops. The method further includes feeding an output of the dry nutrients from the container into a manifold. The method further includes separating the output of the dry nutrients into row-wise deliveries. The method further includes conveying the row-wise deliveries from the manifold to the rows of crops. The method further includes feeding a stream of crop-yield increasing liquid from the liquid container through a liquid-conveyor duct to a plurality of spray nozzles for discharge onto leaves of the row crops simultaneously with the step of distributing row-wise deliveries directly to root structures of the row crops.

In illustrative embodiments, the method further includes distributing the row-wise deliveries directly to root structures of the row crops. The step of providing a vehicle further includes providing a boom coupled to the vehicle.

In illustrative embodiments, the step of conveying the row-wise deliveries from the manifold to the rows of crops further includes spreading the row-wise deliveries along a length of the boom.

In illustrative embodiments, the method further includes metering the output of dry nutrients based on predetermined conditions associated with a geographic area. The step of metering the output of dry nutrients may include adjusting a speed of the vehicle. The step of metering the output of dry nutrients may include adjusting an outlet valve. The step of metering the output of dry nutrients may include varying a feed system coupled between the container and the manifold.

In illustrative embodiments, the method further includes diffusing a first row-wise delivery toward the root structure of a first row of crops. The method further includes diffusing the first row-wise delivery toward the root structure of a second row of crops. The method further includes opening the soil adjacent to a first row of crops to provide a first trench and diffusing the first row-wise delivery into the first trench. The method further includes opening the soil adjacent to a second row of crops to provide a second trench and diffusing the first row-wise delivery into the first and second trenches.

According to another aspect of the present disclosure, a vehicle for distributing nutrients includes a frame, an prime mover coupled to the frame, and a distribution system. The prime mover includes an engine, a hydraulic pump, and a hydraulic motor. The engine is configured to provide power for the hydraulic pump and the hydraulic pump configured to provide pressure to drive the hydraulic motor. The distribution system is configured to simultaneously distribute nutrients directly to a root structure of a mature row crop and a crop-yield increasing liquid to the leaves of the mature row crop.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of a vehicle that is configured to distribute bulk quantities of dry nutrients to mature-row crops;

FIG. 2 is a perspective view of the vehicle moving through rows of crops and distributing the dry nutrients directly to the root structure of the crops;

FIG. 3 is a diagrammatic view of the vehicle of FIGS. 1 and 2 showing that the vehicle includes a frame, a prime mover, a distribution system, and a control system;

FIG. 4 is a diagrammatic view of a diffusion system included in the distribution system of FIG. 3 showing that the diffusion system includes a manifold, a toolbar kit and a plurality of diffusers coupled to the toolbar kit;

FIG. 5 is a diagrammatic view of the control system of FIG. 3 showing that the control system includes a GPS system and a controller having a processor and memory and showing that the controller is configured to store data associated with predetermined conditions;

FIG. 6 is a side view of a portion of the distribution system of FIG. 3 showing that the distribution system includes a container and a metering unit coupled to the container;

FIG. 7 is a side view of a portion of the diffusion system of FIG. 4 showing that the manifold includes a plenum coupled to the feed system and a plurality of ducts extending from the plenum toward the toolbar kit;

FIG. 8 is a top view of the toolbar kit of FIG. 4 showing that the plurality of ducts are separated and received by first and second duct carriers and showing that the ducts travel through the duct carriers toward a toolbar;

FIG. 9 is an enlarged perspective view of one duct carrier of FIG. 8 showing that the duct carrier includes a housing, a mount, and a duct retainer;

FIG. 10 is a partial exploded view of a single arm included in the plurality of arms showing that the arm includes an opener unit coupled selectively to a distal end of the arm and showing that a single diffusor is coupled to the arm adjacent to the opener unit for diffusing dry nutrients toward the opener unit;

FIG. 11 is a top view of the opener unit of FIG. 10 showing that the opener unit includes a T-shaped mount and a plurality of openers couple to the T-shaped mount and suggesting that the openers are adjustable along the T-shaped mount;

FIG. 12 is a front elevation view of the opener unit of FIGS. 10 and 11 showing that the diffuser is configured to diffuse dry nutrients towards each opener included in the plurality of openers;

FIG. 13 is a front elevation view of the diffuser of FIG. 10 showing that the diffuser includes a body, a plurality of diffusion ports, and a plurality of overflow ports;

FIG. 14 is a top view of the diffuser showing that the body of the diffuser includes an inlet port that is configured to receive a duct to conduct the dry nutrients from the duct to the diffuser;

FIG. 15 is second embodiment of a vehicle that is configured to distribute bulk quantities of dry nutrients to mature-row crops;

FIG. 16 is another embodiment of a portion of a diffusion system included in the second embodiment of the vehicle that is configured to distribute bulk quantities of dry nutrients to mature-row crops;

FIG. 17 is an enlarged view of another embodiment of a diffusor configured to diffuse dry nutrients directly to the root structure of mature-row crops;

FIG. 18 is a perspective view of a third embodiment of a vehicle and a kit that is configured to couple to the vehicle to retrofit the vehicle for distribution of bulk quantities of dry nutrients to mature-row crops;

FIG. 19 is a perspective view of the vehicle and the kit in a partially-assembled configuration;

FIG. 20 is a diagrammatic view of a diffusion system included in the vehicle;

FIG. 21 is a cross sectional view of a portion of the diffusion system showing a quick connect system included in the kit of FIGS. 18-20;

FIG. 22 is a diagrammatic view of a third embodiment of a vehicle including a rear-mounted distribution system that is configured for distribution of bulk quantities of dry nutrients to mature-row crops;

FIG. 23 is a front perspective view of a third embodiment of a vehicle that is configured to simultaneously deliver dry nutrients and liquid crop-yielding products to mature row crops;

FIG. 24 is a perspective view of an underbody of the vehicle showing how a plurality of tubes extend from a meter unit toward a front of the vehicle to a plurality of drop tubes coupled to a sprayer boom of the vehicle;

FIG. 25 is a perspective view of the meter unit and a plurality of outlet ports coupled to the meter unit to each receive individual applications of the dry nutrients from the meter unit;

FIG. 26 is perspective view of a portion of the sprayer boom with the plurality of drop tubes and a plurality of liquid-spray nozzles coupled to the sprayer boom; and

FIG. 27 is a perspective view of the sprayer boom in use in a field with mature row crops simultaneously applying dry nutrients directly to the roots of the mature row crops and spraying a pesticide on the leaves of the mature row crops.

### DETAILED DESCRIPTION OF THE DRAWINGS

Although certain illustrative embodiments have been described in detail above, variations and modifications exist within the scope and spirit of this disclosure as described and as defined in the following claims.

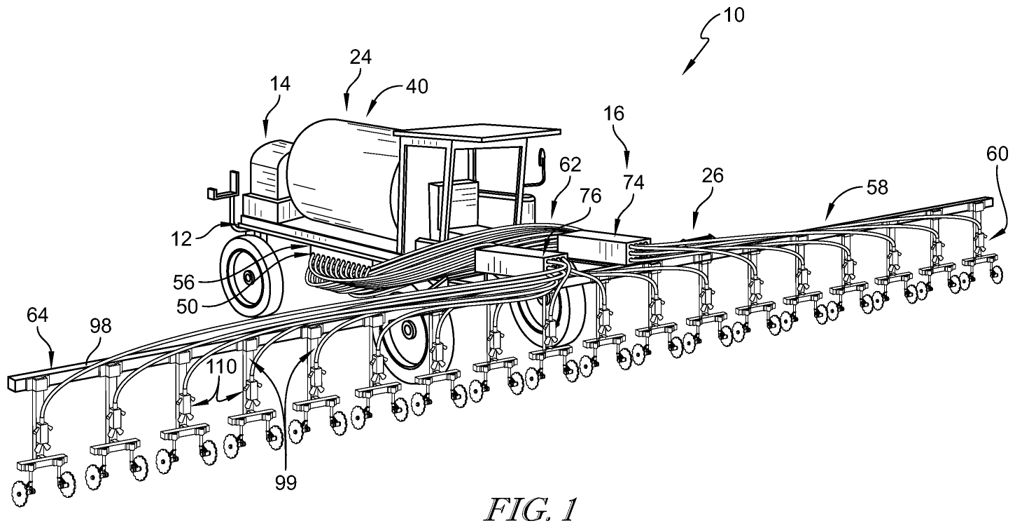

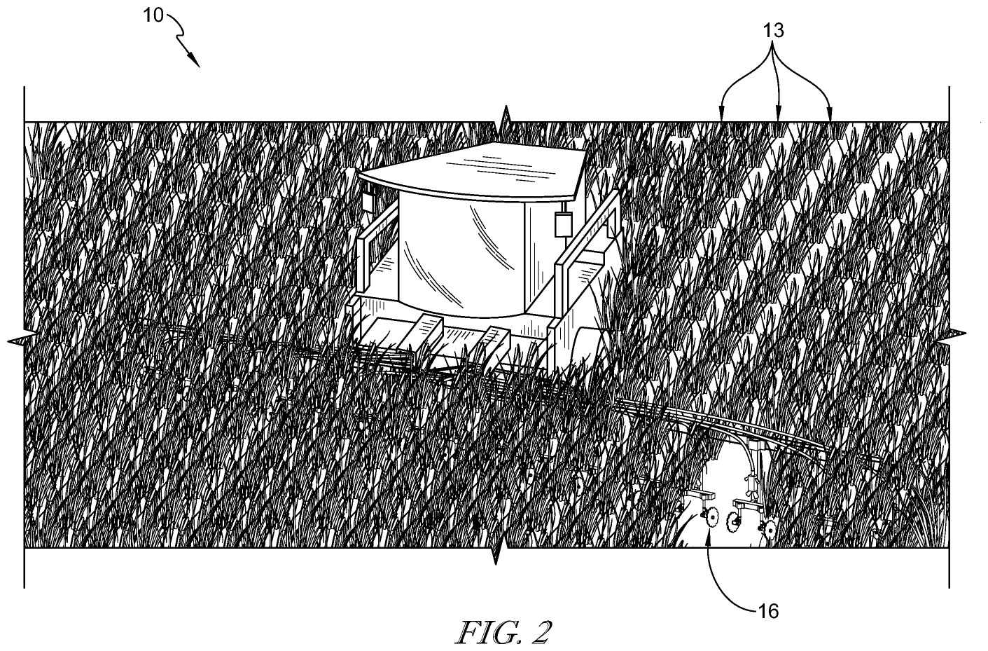

A vehicle 10 in accordance with the present disclosure is shown in FIGS. 1 and 2. The vehicle 10 is configured to distribute dry nutrients to mature row crops and includes a frame 12, a prime mover 14, and a dry-nutrient distribution system 16. The frame 12 supports the prime mover 14 and the distribution system 16 as the vehicle 10 moves through the rows of the mature crops 13. The prime mover 14 supplies power for the vehicle 10 so that the vehicle may move through the rows of crops as shown in FIG. 2 and distribute nutrients to the crops. The distribution system 16 is coupled to the frame 12 and powered by the prime mover 14 and is configured to diffuse dry nutrients directly to the root structure of the mature row crops 13.

Rowed crops, such as corn, typically follow nutrient uptake patterns as the crops progress through vegetative stages and reproductive stages that make up the crops growth cycle. The uptake of nutrients refers to a percentage or an amount (such as lb/acre) of nutrients used by the crops during their growth cycle. In the illustrative embodiment, the distribution system 16 is configured to convey dry nutrients, such as nitrogen and potassium, directly to the roots of the crops when nutrient uptake is at a maximum to increase crop yield and increase nutrient use efficiencies. For Example, the crops may use between about 55-75 percent of their total nitrogen and between about 65-80 percent of their total potassium after the tassel of the crop has formed in its growth cycle. In one example, the dry nutrients are applied between about the V10 stage to about the V16 stage. In another example, the dry nutrients are applied about two weeks prior to tassel formation.

The row crops root structure includes the roots of the crops and the soil adjacent to the roots of the crops. In accordance with the present disclosure, dry nutrients may be distributed within about 10 days of a rainfall that is sufficient to wash the nutrients into soil and absorbed by the roots of the crops. In the illustrative embodiment, the distribution system 16 applies the dry nutrients directly to the root structure of mature row crops as suggested in FIG. 2 where they are washed into the soil and absorbed by the roots of the crops to maximize growth of the crops and, therefore, crop yield.

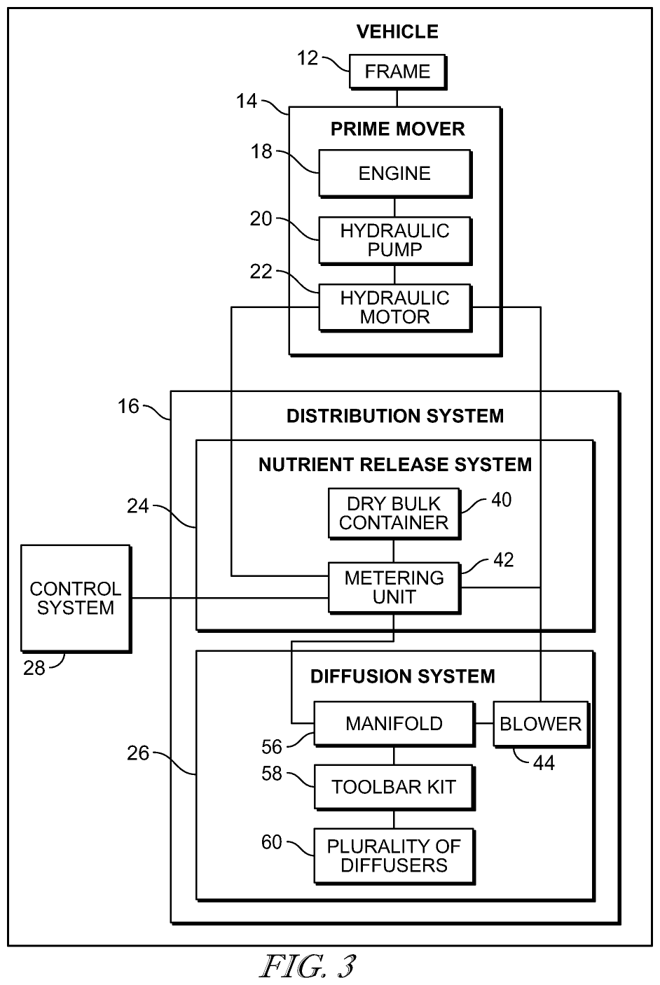

In the illustrative embodiment, the prime mover 14 includes an engine 18, a hydraulic pump 20, and a hydraulic motor 22 as shown in FIG. 3. The engine 18 supplies power for the vehicle 10 and the hydraulic pump 20. The hydraulic pump 20 provides pressure sufficient to operate at least one hydraulic motor 22. The hydraulic motor 22 provides power to operate one or more features included in vehicle 10 such as the distribution system 16 as will be explained in greater detail below.

The distribution system 16 includes a nutrient release system 24 and a diffusion system 26 as shown in FIG. 3. The nutrient release system 24 is configured to store a bulk quantity of dry nutrients and deliver an output of the dry nutrients to the diffusion system 26 as needed. The diffusion system 26 conveys the output of dry nutrients from the nutrient release system 24 directly to the root structure of the mature row crops. In the illustrative embodiment, the dry nutrients include primarily nitrogen. In other embodiments, other dry nutrients may be diffused by distribution system 16 such as, for example, phosphate, potassium, ammonium nitrate, ammonium sulfate, diammonium phosphate, potassium chloride, potassium sulfate, potassium magnesium sulfate, triple super phosphate, urea, or any other dry nutrient or combination thereof.

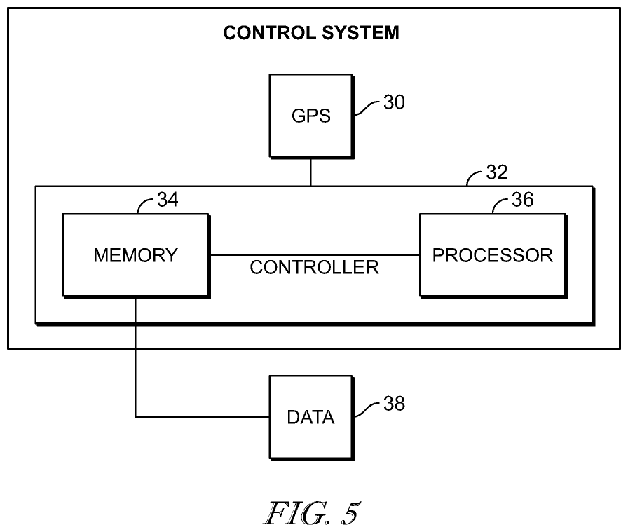

The vehicle 10 further includes a control system 28 that is configured to vary the output of the dry nutrients from the nutrient release system 24 and the diffusion system 26 based on predetermined conditions. The control system 28 includes a global positioning system (GPS) 30 and a controller 32 as shown in FIG. 5. The GPS 30 determines a geographical position of the vehicle 10 relative to a field of row crops. The controller 32 is configured to command the nutrient release system 24 to vary the output of dry nutrients based on the predetermined conditions associated with the geographical position determined by the GPS 30 as is known in the art.

The predetermined conditions include a number of variables associated with crop growth. The predetermined conditions include, but are not limited to: soil type, ground fertility, rain maps, nitrogen models, tile maps, and normalized difference vegetation indexes. The controller 32 includes a memory 34 and a processor 36. The memory 34 is configured to store data associated with the predetermined conditions. The processor 36 is configured to command the nutrient-release system 24 to vary the output of dry nutrients in any given geographic location. As such, the GPS 30 and the controller 32 cooperate to provide an optimum output of dry nutrients to each and every geographical position included in the field of row crops based on the predetermined conditions.

In the illustrative embodiment, data 38 is stored in the memory 34 by user inputs as shown in FIG. 5. The user inputs may include predetermined conditions associated with a particular region or a particular field of crops. In other embodiments, the control system 28 is configured to update the predetermined conditions and store the updated conditions in the memory 34 automatically.

The nutrient release system 24 includes a dry-bulk container 40 and a nutrient-metering unit 42 as shown in FIG. 3. The dry-bulk container 40 stores the bulk quantity of dry nutrients. The nutrient-metering unit 42 is coupled to the dry-bulk container 40 and is configured to supply the output of dry nutrients to the diffusion system 26. A blower 44 is configured to move the dry nutrients from the nutrient release system 24 and through the diffusion system 26 to be applied directly to the root structure of the mature row crops.

The nutrient-metering unit 42 includes a feed system 46 and a scale 48 as shown in FIG. 6. The feed system 46 is configured to convey the output of dry nutrients from the dry-bulk container 40 into a manifold 56. The scale 48 is coupled to the dry-bulk container 40 and measures an amount of dry nutrients remaining in the dry-bulk container. In some embodiments, the control system 28 receives signals from the scale 48 and adjusts the output of dry nutrients as the amount of dry nutrients in the dry-bulk container 40 depletes during operation of the vehicle 10 in the field of row crops. In another example, the control system 28 regulates the speed of the vehicle 10 to adjust the output of dry nutrients.

The feed system 46 is coupled to the nutrient release system 24 between the dry bulk container 40 and the manifold 56. In the illustrative embodiment, the feed system 46 includes a first auger 52 and a second auger 54 to move the dry nutrients from the dry-bulk container 40 to the manifold 56. The first and second augers 52, 54 are interlocked and counter rotate relative to one another to move the dry nutrients from dry-bulk container 40 to the manifold 56. In other embodiments, any suitable number of augers may be used to move the dry nutrients from the dry-bulk container 40 to the manifold 56.

In one example, the speed of rotation of augers 52, 54 is regulated by the control system 28 to meter the output of dry nutrients based on the predetermined conditions. In another example, the feed system 46 further includes valves that may be opened and closed to vary the output of dry nutrients. The valves may be opened fully or partially depending on the output of dry nutrients required in any given geographic position in the field of crops.

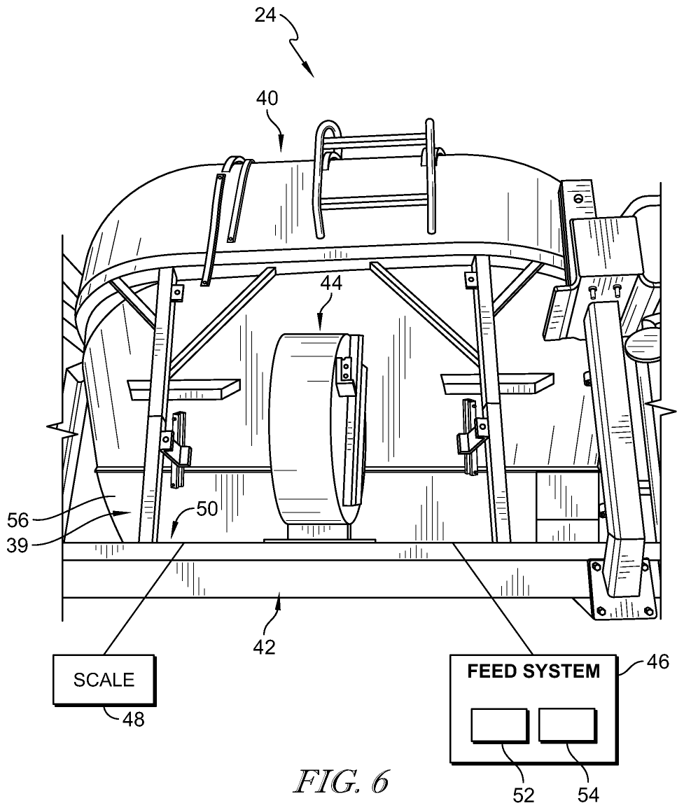

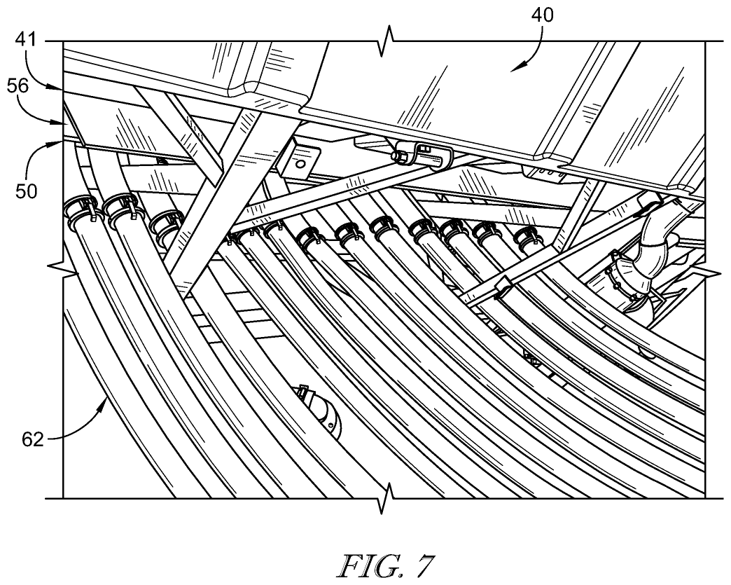

After the optimum output of nutrients is determined by the control system 28 and conveyed into the manifold 56, the dry nutrients are moved through the diffusion system 26 by the blower 44. The blower 44 is coupled to the manifold 56 on a first side 39 of the manifold 56 as shown in FIG. 6. The blower 44 directs air and the output of dry nutrients from the first side 39 of the manifold 56 to a second side 41 of the manifold 56 as shown in FIG. 7. In other embodiments, the blower directs air and the output of dry nutrients from a rear of the vehicle 10 toward a front of the vehicle. In the illustrative embodiment, the blower 44 includes a centrifugal fan mounted to the nutrient release system 24 on one side of the manifold 56. In other embodiments, any suitable type of blower or fan may be used.

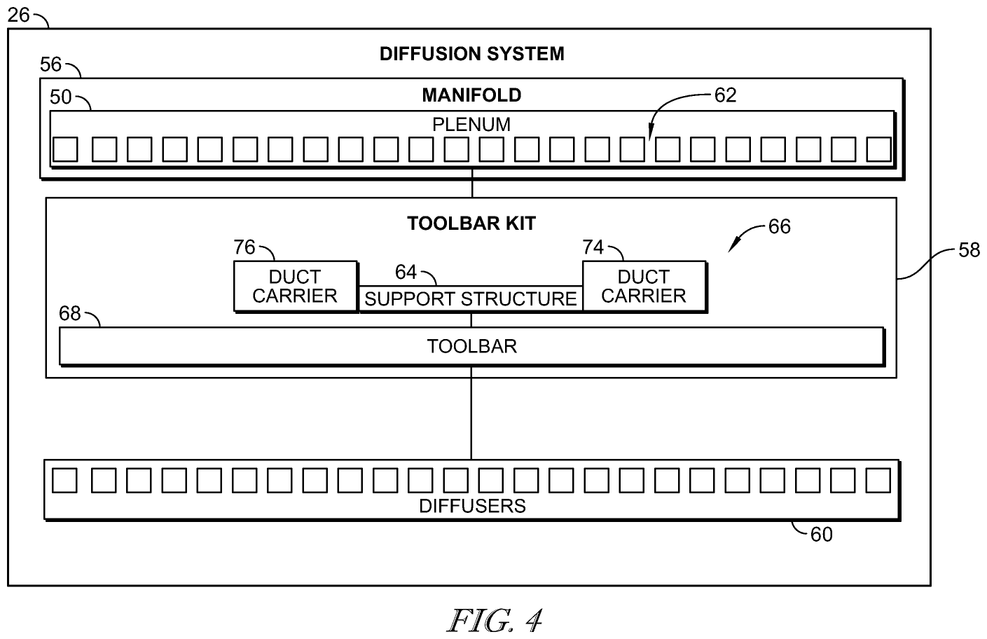

The diffusion system 26 includes the manifold 56, a toolbar kit 58, and a plurality of diffusers 60 as shown in FIG. 4. The manifold 56 divides the output of dry nutrients into row-wise deliveries. The toolbar kit 58 collects the row-wise deliveries and directs each row-wise delivery to a row of crops. The diffusers 60 direct the row-wise deliveries directly at the root structure of each row of crops.

The manifold 56 includes a plenum 50 and a plurality of ducts 62 as shown in FIG. 7. As described above, the plenum 50 receives the output of dry nutrients from the feed system 46. The blower 44 pushes the dry nutrients from the plenum 50 through each duct 62. The ducts 62 extend from the plenum 50 toward the toolbar kit 58. Each duct 62 conveys a row-wise delivery of the dry nutrients from the plenum 50 to a corresponding diffuser 60.

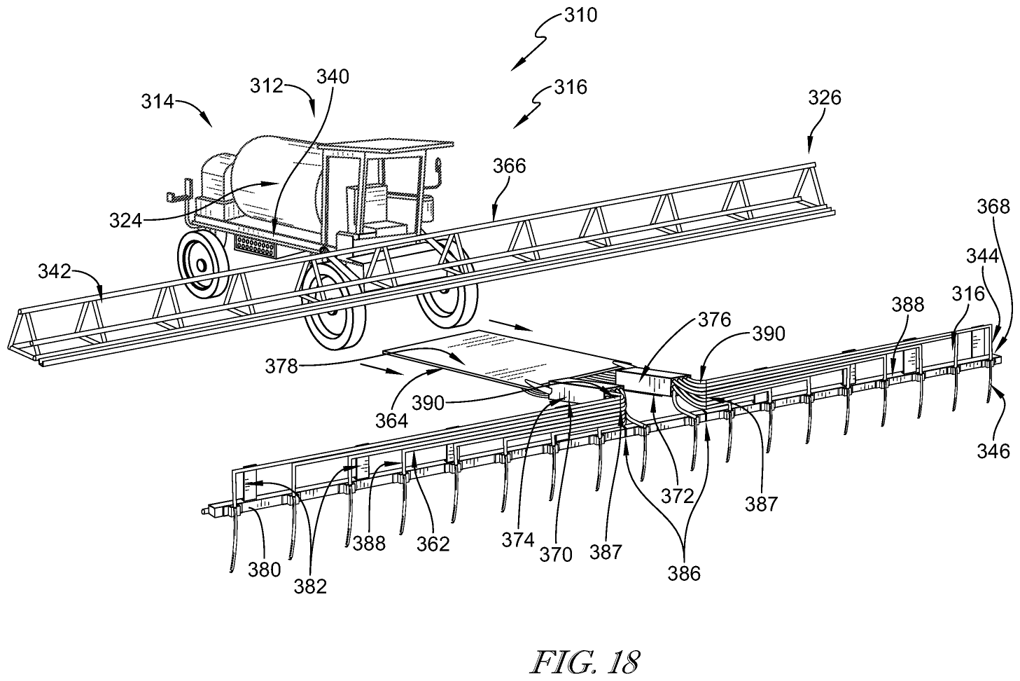

The toolbar kit 58 includes a support structure 64, a duct carriage 66, and a toolbar 68 as shown in FIG. 4. The support structure 64 is coupled to the frame 12 of the vehicle 10 and may be raised and lowered relative to the frame 12. The duct carriage 66 is coupled to the support structure 64 and receives the ducts 62 from the manifold 56. In another embodiment, the duct carriage 66 is coupled to the frame 12 beneath the vehicle 10 as shown in FIGS. 18-21 and described below. The toolbar 68 is coupled to the support structure 64 for up-and-down movement with the support structure 64 and extends outward away from the vehicle 10 in both lateral directions.

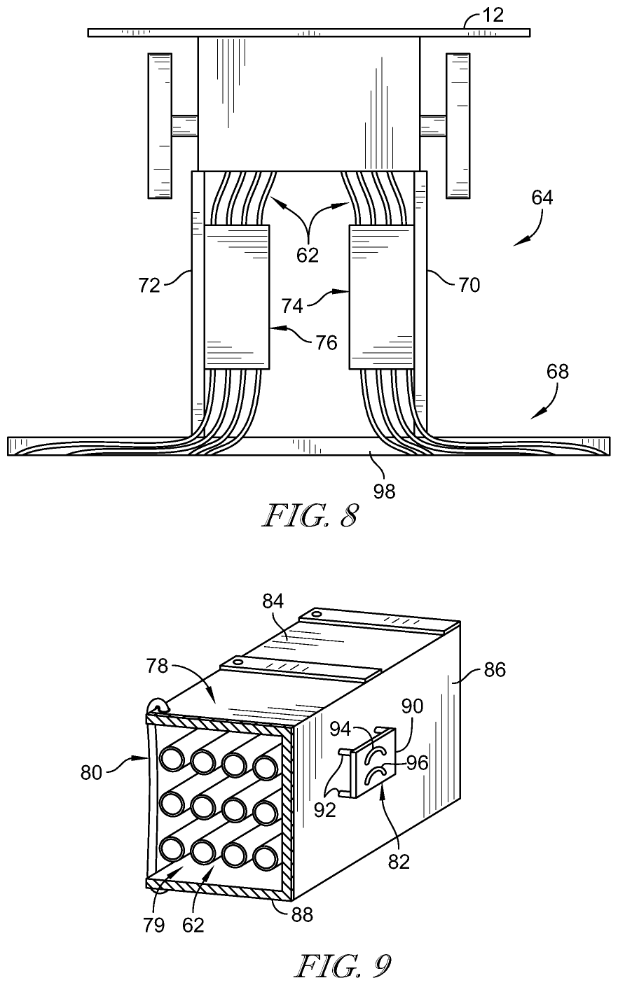

The toolbar 68 spans a length in front of the vehicle. The toolbar 68 is configured to apply dry nutrients to each row of crops within the length of the toolbar 68. The ducts 62 spread from the duct carriage 66 and are separated along the length of the toolbar 68 to deliver the row-wise deliveries of the dry nutrients to each row of crops within the length of the toolbar 68. Support structure includes a first arm 70 and a second arm 72 spaced apart from the first arm 70 as shown in FIG. 8. Each arm 70, 72 extends outwardly from a front of vehicle 10. The arms 70, 72 cooperate to raise and lower the toolbar 68 to accommodate crops of different heights.

In the illustrative embodiment, the duct carriage 66 includes a first duct carrier 74 coupled to the first arm 70 and a second duct carrier 76 coupled to the second arm 72 as shown in FIG. 8. The first duct carrier 74 is shaped to receive a first half of the ducts 62 and the second duct carrier 76 is shaped to receive a second half of the ducts 62. In the illustrative embodiment, the first duct carrier 74 receives twelve ducts and directs the twelve ducts to a right half of the toolbar 68. Conversely, the second duct carrier 76 receives an additional twelve ducts and directs the twelve ducts to a left half of the toolbar 68.

Although the ducts 62 are divided equally between the two duct carriers 74, 76, it should be appreciated that any fraction of the ducts 62 may be received within each duct carrier 74, 76. Additionally, any number of ducts 62 may extend from the manifold 56 to the toolbar 68. As such, the length of the toolbar 86 may be adjustable to service any number of rows of crops.

The second duct carrier 76 is shown in detail in FIG. 9. Although only the first duct carrier 74 is shown in FIG. 9, second duct carrier 76 is similar to first duct carrier 74. As such, all disclosure related to duct carrier 74 is hereby incorporated herein for duct carrier 76. The first duct carrier 74 includes a duct housing 78, a duct retainer 80, and a carrier mount 82. The duct housing 78 is formed to include a duct-receiving space 79 that has a square or rectangular shape. The duct retainer 80 retains the ducts 62 within the duct housing 78. The carrier mount 82 is coupled to the duct housing 78 and mounts the duct carrier 76 to the support structure 64.

In the illustrative embodiment, the duct housing 78 has a first side wall 84, a second side wall 86, and a third side wall 88. The duct retainer 80 extends from the first side wall 84 to the third side wall 88 and is removable selectively to add or remove ducts 62 from the duct receiving space 79.

The carrier mount 82 is coupled to the second side wall 86 of the duct housing and includes a bracket 90 and a plurality of support posts 92 as shown in FIG. 9. The bracket 90 is formed to include first and second curvilinear apertures 94, 96. The support posts 92 extend from the second side wall 86 to the bracket 90 so that the bracket is spaced apart from the second side wall 86. Fasteners (not shown) extend through the curvilinear apertures 94, 96 and couple to the support structure 64 to mount the carrier mount 82 to the support structure 64. The curvilinear apertures 94, 96 allow the carrier mount 82 to pivot relative to the support structure 64 as the support structure 64 is raised and lowered.

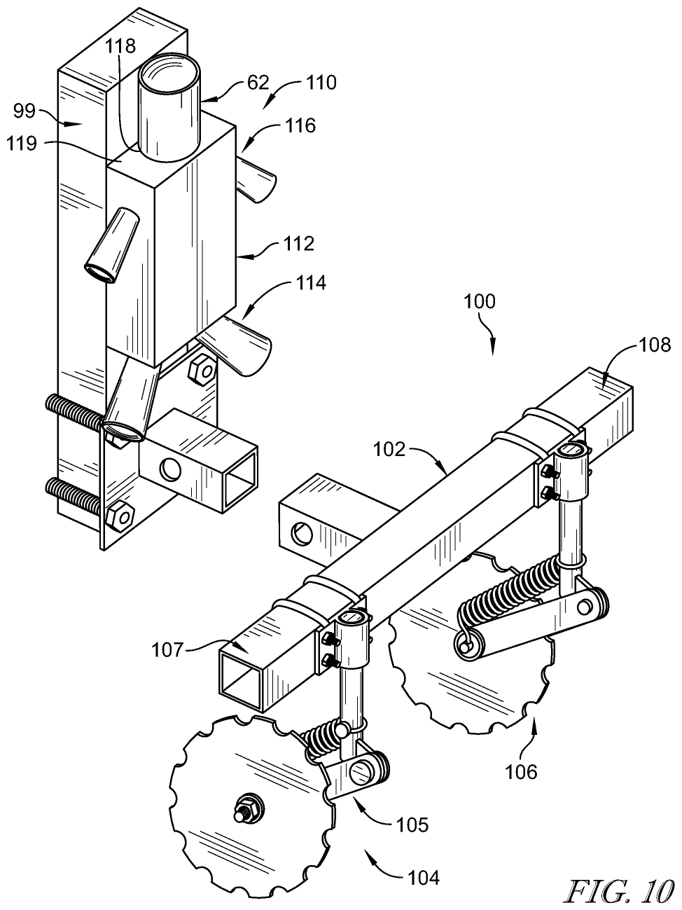

The toolbar 68 includes a toolbar beam 98, a plurality of arms 99 and an opener unit 100 coupled to a distal end of each arm 99 as shown in FIGS. 1 and 10. The toolbar beam 98 supports the arms 99 and the opener units 100 on the toolbar 68. The arms 99 are arranged to extend downwardly from the toolbar beam 98 past the leaves of the crops between adjacent rows of crops. The opener units 100 engage the soil between the rows of crops and are configured to create trenches adjacent to each row of crops so that dry nutrients may be diffused into the trenches. Diffusing the dry nutrients into the trenches applies the dry nutrients in close proximity to the roots of the mature row crops improving the delivery to the mature crops.

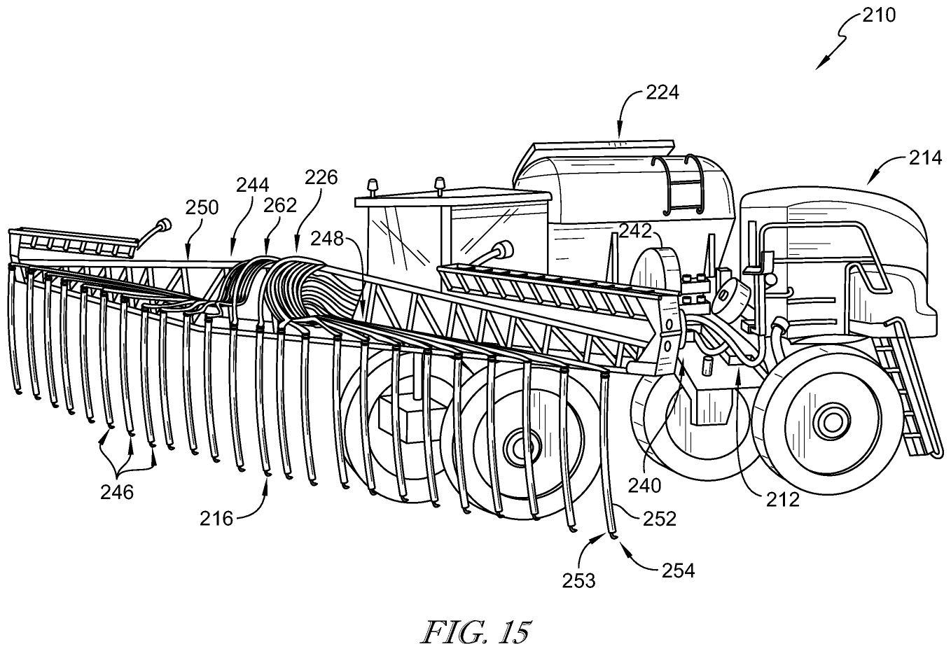

In the illustrative embodiment, eighteen arms 99 extend downwardly from the toolbar 68 as shown in FIG. 1 and twenty-four arms 99 extend downwardly from the toolbar as shown in FIG. 15. However, any suitable number of arms 99 may be used.

Each opener unit 100 includes a mount 102 and an opener assembly 104 as shown in FIG. 10. The mount 102 is T-shaped and is adapted to couple selectively to the distal end of an arm 99. In the illustrative embodiment, the opener assembly 104 includes a first opener 105 and a second opener 106. The first opener 105 is coupled to a first end 107 of the mount 102. The second opener 106 is coupled to a second end 108 of the mount 102. Each opener 105, 106 is configured to form a trench in soil adjacent to a respective row of crops. As such, in the illustrative embodiment, the opener unit 100 is configured to create a trench on each side of the row of crops and provides dual trenches between each row of crops. This allows nutrients to be applied to both sides of each row of crops.

The mount 102 is removable selectively from the arm 99. A wider mount 104 may be used to accommodate rows of crops of varying widths. Additionally, a mount with a higher or lower number of openers may be used. As such, any suitable number of openers may be included on the distal end of each arm 99.

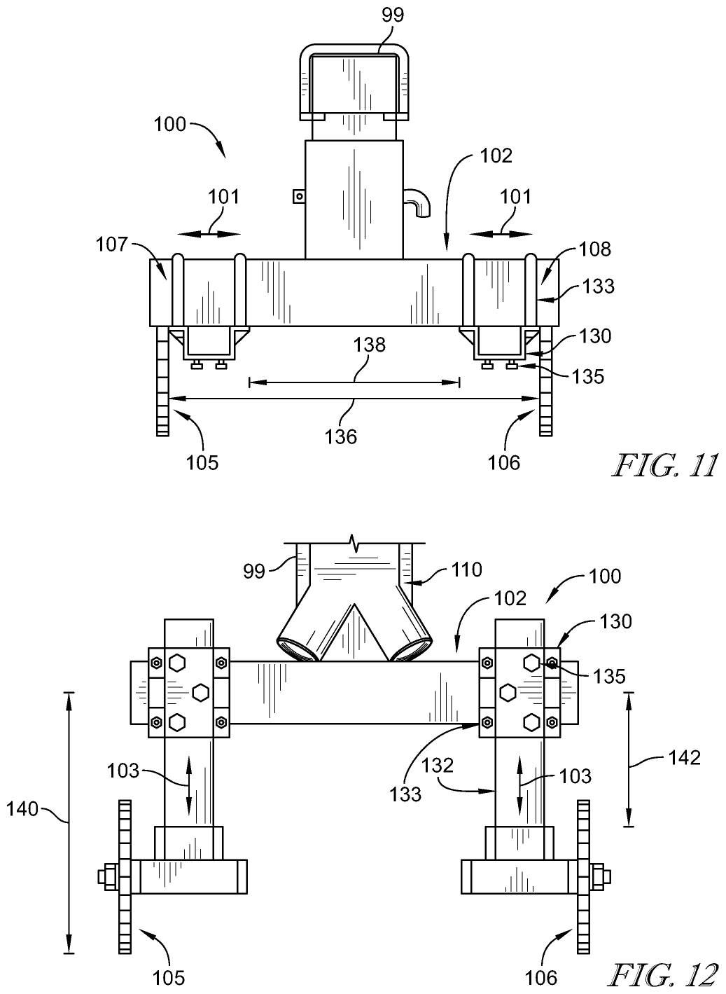

The openers 105, 106 are adjustable in-and-out relative to the mount 102 as suggested by arrows 101 in FIG. 11 and up-and-down relative to the mount 102 as suggested by arrows 103 in FIG. 12. The openers 105, 106 may be adjusted to accommodate rows of crops of varying widths and crops of varying heights. Each opener 105, 106 is coupled to the mount 102 by a mount system 128 that includes a bracket 130, a mount post 132, and fasteners 134. The bracket 130 couples the opener unit 104 to the mount 102. The mount post 132 extends downwardly from the bracket 130. The openers 105, 106 are coupled to an end of the mount post 132. The fasteners 134 secure the bracket 130 and the mount post 132 to the mount 102.

In one example, a user may adjust the openers 105, 106 inwardly from a first width 136 to a second width 138 as shown in FIG. 11. Additionally, a user may adjust the openers 105, 106 from a first height 140 to a second height 142 as shown in FIG. 12. However, openers 105, 106 may be adjusted to any suitable width between one another and height relative to the mount 102.

The fasteners 132 include u-shaped fasteners 133 that extend around the mount 102 and couple to the bracket 130 to retain the bracket 130 to the mount 102. The u-shaped fasteners 133 are loosened to allow the bracket 130 to translate inwardly or outwardly relative to the mount 102 to adjust the width of the openers 105, 106. Additional fasteners 135 extend through the bracket and engage the mount post 132 to retain the mount post at the height selected by the user. The fasteners 135 may be loosened to allow the mount post 132 to translate upwardly or downwardly to adjust the height of the openers 105, 106.

A diffuser 110 is coupled to each arm 99 as shown in FIGS. 1, 10, 13, and 14. The diffuser 110 is configured to direct dry nutrients directly at the trenches created by the openers 105, 106 as the vehicle moves through the field of crops. Each diffuser 110 includes a body 112, an outlet chamber 114, and an overflow unit 116. The body is generally rectangular and is formed to include an inlet 118 in an upper end 119 of the body 112. The inlet 118 is shaped to receive a duct 62 to receive a row-wise delivery of dry nutrients in the diffuser 110. The outlet chamber 114 is coupled to a lower end 121 of the body 112 and is configured to diffuse the row-wise delivery of dry nutrients towards the openers 105, 106. The overflow unit 116 is located between the outlet chamber 114 and the upper end 119 of the body 112.

In the illustrative embodiment, the body 112 has a width W1 of about four inches as shown in FIG. 14. However, any suitable width W1 may be used. The body 112 has a thickness T1 of about three inches. However, any suitable thickness T1 may be used.

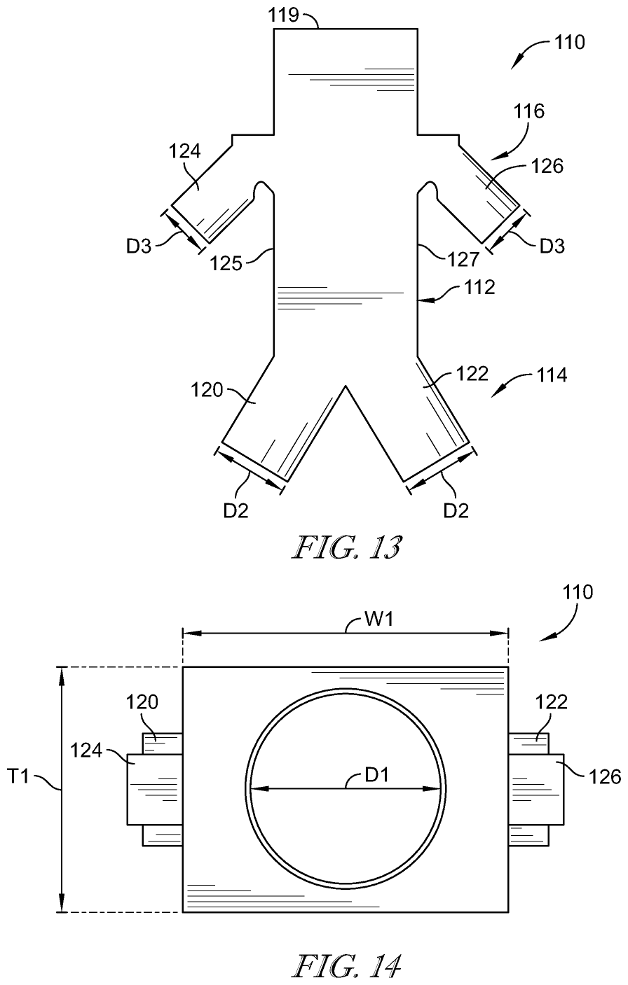

The outlet chamber 114 includes a first conduit 120 and a second conduit 122 as shown in FIG. 13. The first conduit 120 extends downwardly from the body 112 at an angle. The second conduit 122 extends downwardly from the body 112 at an angle opposite the first conduit 120. The first conduit 120 diffuses dry nutrients toward the first opener 105 while the second conduit 122 diffuses dry nutrients toward the second opener 106.

The overflow unit 116 is configured to diffuse nutrients toward the openers 105, 106 if the outlet chamber 114 becomes clogged with dry nutrients. The overflow unit 116 includes a first overflow conduit 124 and a second overflow conduit 126 as shown in FIG. 13. The first overflow conduit 124 is arranged to extend from a first side 125 of the body 112. The second overflow conduit 126 is arranged to extend from a second side 127 of the body 112. Dry nutrients exit out of the first and second overflow conduits 124, 126 if the outlet chamber 114 becomes clogged.

In the illustrative embodiment, the inlet 118 has a diameter D1 that is about 2.5 inches as shown in FIGS. 13 and 14. However, any suitable diameter for the inlet 118 may be used. Each outlet conduit 120, 122 has a diameter D2 that is about 1.5 inches. However, any suitable diameter for the outlet conduits 120, 122 may be used. Each overflow conduit 124, 126 has a diameter D3 that is about 1 inch. However, any suitable diameter for the overflow conduits 124, 126 may be used.

In the illustrative embodiment, the distribution system 16 is configured to distribute nutrients containing primarily nitrogen directly to the root structure of the crops. Prior devices and methods are unable to distribute dry nutrients directly to the root structure of the crops. Instead, prior devices and methods spread the dry nutrients crop foliage where the dry nutrients are blocked from being applied directly to the roots.

Another embodiment of a vehicle 210 that is configured to deliver dry nutrients to mature row crops, in accordance with the present disclosure, is shown in FIGS. 15-17. The vehicle 210 includes a frame 212, an engine 214, and a distribution system 216. The frame 212 and the engine 214 are similar to the frame 12 and the prime mover 14 of vehicle 10. As such, disclosure related to frame 12 and prime mover 14 are hereby incorporated herein for frame 212 and engine 214.

The distribution system 216 includes a nutrient release system 224 and a diffusion system 226 as shown in FIG. 15. The nutrient release system 224 is similar to the nutrient release system 24 of vehicle 10. As such, disclosure related to nutrient release system 24 is hereby incorporated herein for nutrient release system 224. The control system 28 is configured to vary the output of dry nutrients from the nutrient release system 224 in a similar fashion to that described above.

The diffusion system 226 conveys the output of dry nutrients from the nutrient release system 224 directly to the root structure of the mature row crops. The diffusion system 226 includes a manifold 240, a blower 242, a kit 244, and a plurality of diffusers 246 as shown in FIG. 15. The manifold 240 and the blower 242 are similar to the manifold 56 and the blower 44 of vehicle 10. As such, disclosure related to manifold 56 and blower 44 are hereby incorporated herein for manifold 240 and blower 242.

The kit 244 includes a boom 248 and a support structure 250. The boom 248 is coupled to the frame 212 via the support structure 250 and is movable up-and-down relative to the frame 212. The support structure 250 is coupled to the boom 248 and moves the boom 248 relative to the frame 212. In one example, the duct carriers 74, 76 are mounted to the support structure 250 and guide a plurality of ducts 262 from the manifold 240 to the boom 248.

The boom 248 of the kit 244 spans a length in front of the vehicle 210. The kit 244 applies dry nutrients to each row of crops within the length. The plurality of ducts 262 disperse along the length of the boom 248 to deliver row-wise deliveries of the dry nutrients to each row of crops within the length of the boom 248.

The diffusers 246 are coupled to the boom 248 and extend downwardly from the boom 248 between rows of crops as shown in FIG. 15. Each diffuser 246 includes a rigid conduit 252 and a diffuser 254. The rigid conduits 252 are coupled in fluid communication with a single duct 262 on the kit 244. The rigid conduits 252 extend downwardly between rows of crops toward the root structure of the crops. The diffusers 254 are coupled to a distal end 253 of the rigid conduits 252.

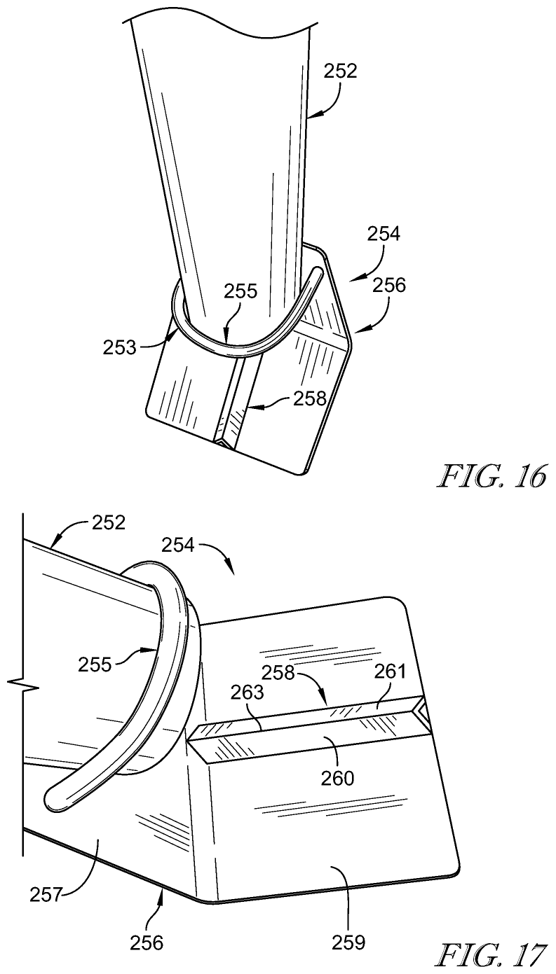

The diffusers 254 are configured to direct the row-wise deliveries of dry nutrients directly toward the root structure of the mature row crops as the vehicle 210 moves through the field of crops. The diffusers 254 include a mount 255, a deflector 256, and a separator 258 as shown in FIGS. 16 and 17. The mount 255 couples the diffusor 254 to the distal end of the rigid conduit 252. The deflector 256 is configured to diffuse the dry nutrients. The separator 258 is coupled to the deflector 256 and is configured to direct a portion of the dry nutrients toward one row of crops and another portion of the dry nutrients toward another row of crops.

The deflector 256 has an attachment plate 257 that is coupled to the mount 255 and a deflection plate 259 that extends at an angle from the attachment plate 257 as shown in FIGS. 16 and 17. The deflector plate 259 is configured to deflect dry nutrients as the dry nutrients flow out of the rigid conduit 252.

The separator 258 is arranged to lie in a generally central region of the deflection plate as shown in FIG. 17. The separator includes a first side wall 260 and a second side wall 261 that converge to form a peak 263. The first side wall 260 directs a portion of the dry nutrients toward one row of crops. The second side wall 262 directs another portion of the dry nutrients toward another row of crops.

Another embodiment of a vehicle 310 that is configured to deliver dry nutrients to mature row crops, in accordance with the present disclosure, is shown in FIGS. 18-21. The vehicle 310 includes a frame 312, an engine 314, and a distribution system 316. The frame 312 and the engine 314 are similar to the frame 12 and the engine 14 of vehicle 10. As such, disclosure related to frame 12 and engine 14 are hereby incorporated herein for frame 312 and engine 314.

The distribution system 316 includes a nutrient release system 324 and a diffusion system 326 as shown in FIG. 18. The nutrient release system 324 is similar to the nutrient release system 24 of vehicle 10. As such, disclosure related to nutrient release system 24 is hereby incorporated herein for nutrient release system 324. The control system 28 is configured to vary the output of dry nutrients from the nutrient release system 324 in a similar fashion to that described above.

The diffusion system 326 conveys the output of dry nutrients from the nutrient release system 324 directly to the root structure of the mature row crops. The diffusion system 326 includes a manifold 240, a primary boom 342, a toolbar kit 344, and a plurality of diffusers 346 as shown in FIG. 18-20. The manifold 340 is similar to the manifold 56 of vehicle 10. As such, disclosure related to manifold 56 are hereby incorporated herein for manifold 340. Blower 44 is also included in the diffusion system 326 to convey the dry nutrients through the diffusion system 326. The primary boom 342 is coupled to a front end of the vehicle 10 and is configured to support at least a portion of the toolbar kit 344. The toolbar kit 58 collects the row-wise deliveries and directs each row-wise delivery to a row of crops. The diffusers 346 direct the row-wise deliveries directly at the root structure of each row of crops.

In the illustrative embodiment, the toolbar kit 344 allows for wide variety of existing vehicles to deliver the dry nutrients to the mature row crops. For Example, the toolbar kit 344 is configured to retrofit an existing boom on a vehicle, such as, for example, a sprayer-type vehicle as shown separate from the kit 344 in FIG. 18. Using the kit 344, the vehicle is then able to deliver the dry nutrients to the mature row crops when such a function may not have been possible using the existing boom 342 and sprayers included in the vehicle.

The toolbar kit 344 includes a support structure 364, a duct carrier 366, and a toolbar 368 as shown in FIGS. 18-20. The support structure 364 is configured to mount to the vehicle to at least partially support the toolbar kit 344 on the vehicle 10. The duct carrier 366 illustratively includes a first duct carrier 374 and a second duct carrier 376 that are substantially similar to duct carriers 74, 76. The toolbar 368 is coupled to the primary boom 342 extends laterally in both directions away from the vehicle 10 with the boom 342 and supports the plurality of diffusers 346 relative to each row of crops.

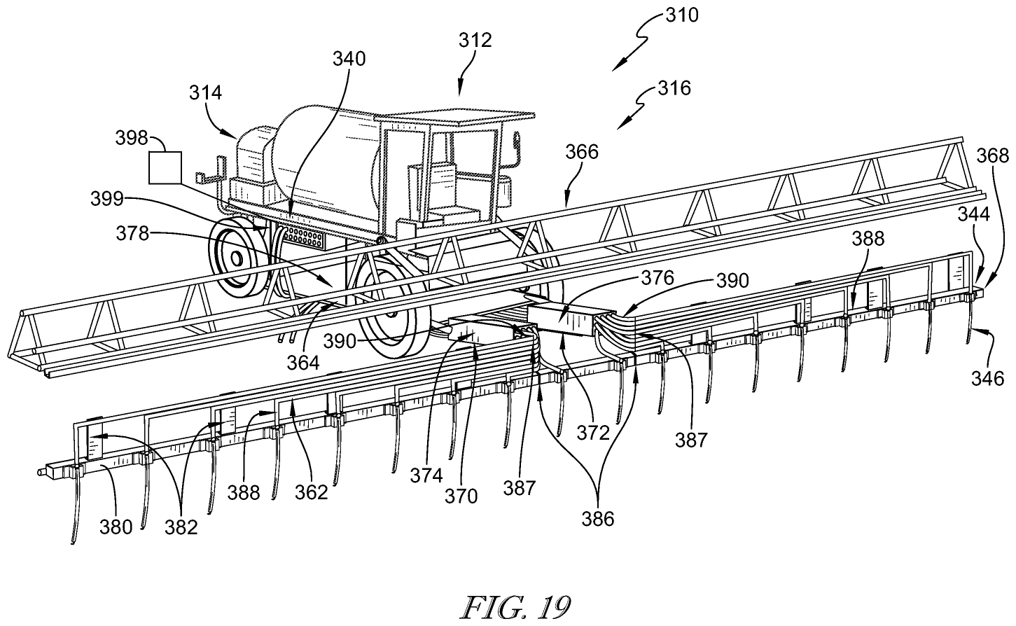

The support structure 364 is configured to carry a plurality of ducts 362 from the toolbar 368 to the manifold 340 and includes a pair of support arms 370, 372 and a support plate 378 as shown in FIGS. 18 and 19. The carriers 374, 376 are coupled to respective arms 370, 372 in a similar manner as described above regarding the coupling of carriers 74, 76 to arms 70, 72. The plurality of ducts 362 extend from the toolbar 368 through each of the carriers 374, 376 and toward the support plate 378. The support plate 378 supports the ducts 362 and directs each of the ducts into communication with respective ports formed in the manifold 340.

As previously discussed, the toolbar 368 is coupled to the primary boom 342 to retrofit the vehicle 10 with the toolbar kit 344. The toolbar 368 includes a support beam 380, a plurality of support rods 382, and a quick connect system 384 as shown in FIGS. 18 and 19. The support beam 380 extends laterally in both directions away from the vehicle 10 with the boom 342 and supports the diffusers 346 and the support rods 382 thereon. The plurality of support rods 382 are spaced apart from one another along a length of the support beam 380 and support at least a portion of the ducts 362 on the toolbar 368. The support rods 382 also support at least a portion of the quick connect system 384. The quick connect system 384 mounts the toolbar 368 to the boom 342 so that the toolbar is supported by the boom 342. The toolbar 368 also includes a hinge 386 on both lateral sides to mimic a hinge function that may be present on the primary boom 342. The hinges 386 allow at least a portion of the toolbar 368 to pivot about the hinges 386 and swing backward toward to the vehicle 10 with the boom 342. At the hinges 386, the ducts 362 may include a connection interface 387. The connection interface 387 has male and female portions that combine to fluidly couple the ducts 362 together to allow the dry nutrients to flow therethrough.

The plurality of ducts 362 include rigid sections 388 and flexible sections 390 as shown in FIGS. 18 and 19. The rigid sections 388 extend along the length of the toolbar 368 to the diffusers 346. The flexible sections 390 are coupled to a proximal end of the rigid sections 388 relative to the vehicle 10 and to the manifold 340. The rigid sections 388 provide a uniform path for each of the ducts along the toolbar 368. The flexible sections 390 allow the ducts 362 to be maneuvered into engagement with a wide variety of manifolds. In the illustrative embodiment, the ducts 362 transition from the rigid sections 388 to the flexible sections at the hinges 386, however, the transition may be made at any suitable location on the kit 344.

In the illustrative embodiment, the rigid sections 388 are made of a metallic material such as, for example, stainless steel; however, any suitable material may be used, such as a rigid plastic material. The flexible sections 390 may also be made of any suitable flexible material, such as, for example, a plastic material or a flexible metallic tubing that is corrugated, woven, or wire based.

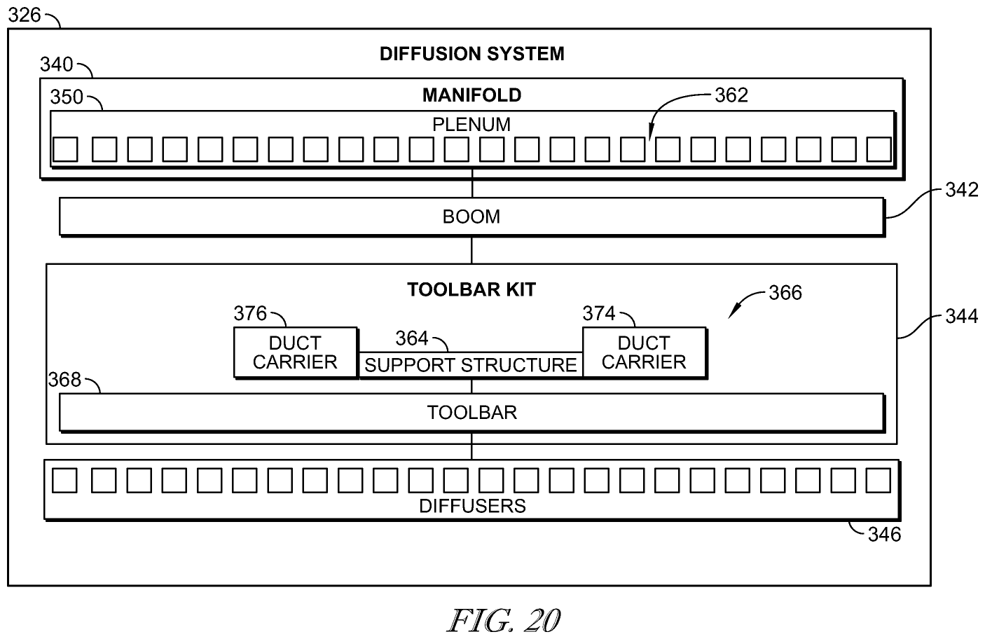

The quick connect system 384 includes a hook structure 392, a corresponding mount 394 configured to engage the hook 392, and a support link 396 as shown in FIG. 20. The hook structure 392 is configured to be mounted to the boom 342 prior to the assembly of the kit 344. A clamp 391 may be used to couple the hook 392 to a portion of the boom 342. Alternatively, a portion of the boom 342 may be manipulated (i.e. by drilling) to accommodate a fastener that is used to couple the hook 392 to the boom 342. The mount 394 is fixed to the support beam 380 and includes a shape suitable for mounting to the hook 392. The support link 396 is coupled to a distal end of a support rod 382 relative to the beam 380 and is also configured to mount to a portion of the boom 342 via a clamp 393 or another suitable mounting method. The support link 396 includes a turnbuckle 397 to adjust the length of the support link 396 and, therefore, the pitch of the toolbar 368 relative to the boom 342.

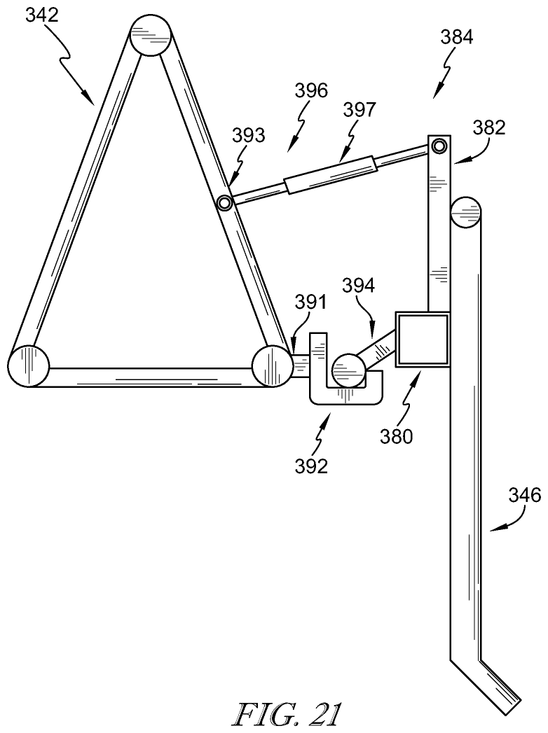

To assemble the toolbar kit 344, the hook 392 of the quick connect system 384 is first coupled to the boom 342 as shown in FIG. 18. Alternatively, the quick connect system 384 may be entirely connected to the toolbar kit 344. The rest of the toolbar kit 344 is positioned on ground in front of the vehicle 10. The vehicle 10 aligns itself with the toolbar kit 344 at a rear end of the toolbar kit 344 and advances forward as suggested by the arrows in front of the vehicle until the support plate 378 is directly under the frame 12 and the manifold 340 as shown in FIG. 19. The primary boom 342 is then configured to engage and lift the support beam 380 of the toolbar kit 344 as suggested in FIG. 19. One or more of the hooks 392 coupled to the boom 342 are used to receive the one or more corresponding mounts 392 to secure and lift the toolbar 368 with the boom 342 (shown in greater detail in FIG. 21). One or more support links 396 are then coupled to the boom 342 and adjusted via the turnbuckle(s) 397. One or more motors 398 located on the frame 12 may be used in conjunction with cables 399 coupled to the support plate 378 to raise the support plate 378 upwardly into engagement with the frame 12. The flexible sections 390 may then be connected to the manifold 340.

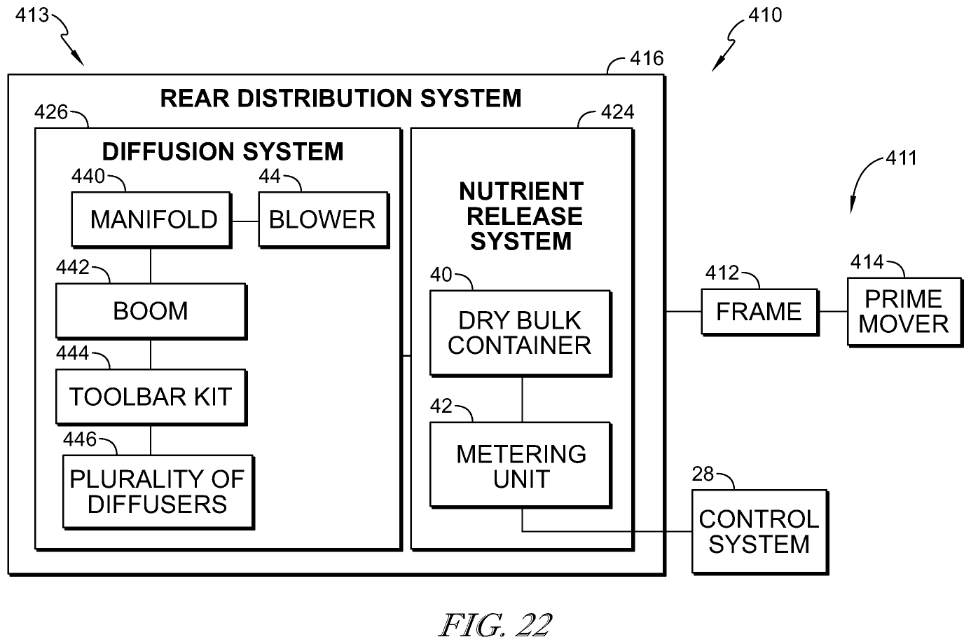

Another embodiment of a vehicle 410 that is configured to deliver dry nutrients to mature row crops, in accordance with the present disclosure, is shown in FIG. 22. The vehicle 410 includes a frame 412, an engine 414, and a distribution system 416. The frame 412 and the engine 414 are similar to the frame 12 and the engine 14 of vehicle 10 except the engine 414 is located at a front end 411 of the vehicle 410. The distribution system 416 is similar to the distribution system 312 except distribution system 416 includes a nutrient release system 424 and a diffusion system 426 that is mounted to a rear-end of the frame 412 as opposed to the front-end mounted system 326 described above. Nutrient release system 424 is similar to nutrient release system 324 and includes dry-bulk container 40 and metering unit 42.

The diffusion system 426 is identical to the diffusion system 326 except that it is mounted to the rear-end 413 of the vehicle 410 as suggested in FIG. 22. The diffusion system 426 includes a manifold 440, a primary boom 442, a toolbar kit 444, and a plurality of diffusers 446. The primary boom 442 is coupled to the rear-end of the vehicle 10 and is configured to support at least a portion of the toolbar kit 444. The toolbar kit 444 collects the row-wise deliveries and directs each row-wise delivery to a row of crops. The diffusers 446 direct the row-wise deliveries directly at the root structure of each row of crops. The blower 44 is also included in the diffusion system 426 to convey the dry nutrients through the diffusion system 426.

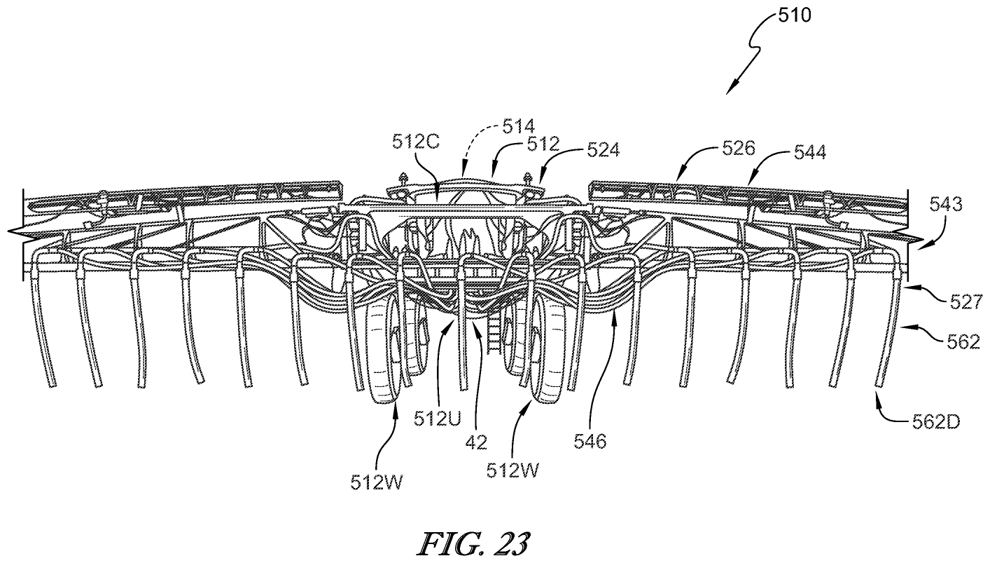

Another embodiment of a vehicle 510 that is configured to simultaneously deliver dry nutrients directly to the roots of mature row crops and to deliver crop-yield increasing liquids to the leaves of the mature row crops, in accordance with the present disclosure, is shown in FIGS. 23-27. The vehicle 210 includes a frame 512, an engine 514, and a distribution system 516. The frame 512 and the engine 514 are similar to frames 12, 212 and engines 14, 214 of vehicles 10, 210. As such, disclosure related to frames 12, 212 and engines 14, 214 are hereby incorporated herein for frame 512 and engine 514.

The distribution system 516 includes a dry-bulk nutrient delivery system 527 and a liquid delivery system 529 as shown in FIGS. 23-27. The dry-bulk nutrient delivery system 527 delivers row-wise applications of dry nutrients to the roots of each row of mature crops within reach. At the same time, the liquid delivery system 529 delivers crop-yield increasing liquids to the leaves of each row of mature crops within reach. The crop-yield increasing liquid may include a fungicide, an insecticide, a herbicide, or a combination of fungicides, insecticides, and herbicides. The dry-bulk nutrients and the crop-yield increasing liquids are delivered at the same time and from the same vehicle 510 to decrease time and the amount of resources, such as fuel, spent if these tasks were performed separately or with different vehicles.

The dry-bulk nutrient delivery system 527 includes a nutrient release system 524 coupled to the vehicle frame 512 and a diffusion system 526 as shown in FIG. 23. The nutrient release system 524 is similar to the nutrient release system 24 of vehicle 10 and includes dry-bulk container 40 and metering unit 42. As such, disclosure related to nutrient release system 24 is hereby incorporated by reference herein for nutrient release system 524. Control system 28 may be included with vehicle 510 and is configured to meter an output of dry nutrients from the nutrient release system 524 in a similar fashion to that described above. The diffusion system 226 conveys the output of dry nutrients from the nutrient release system 224 directly to the root structure of the mature row crops and applies dry nutrients to each row of crops.

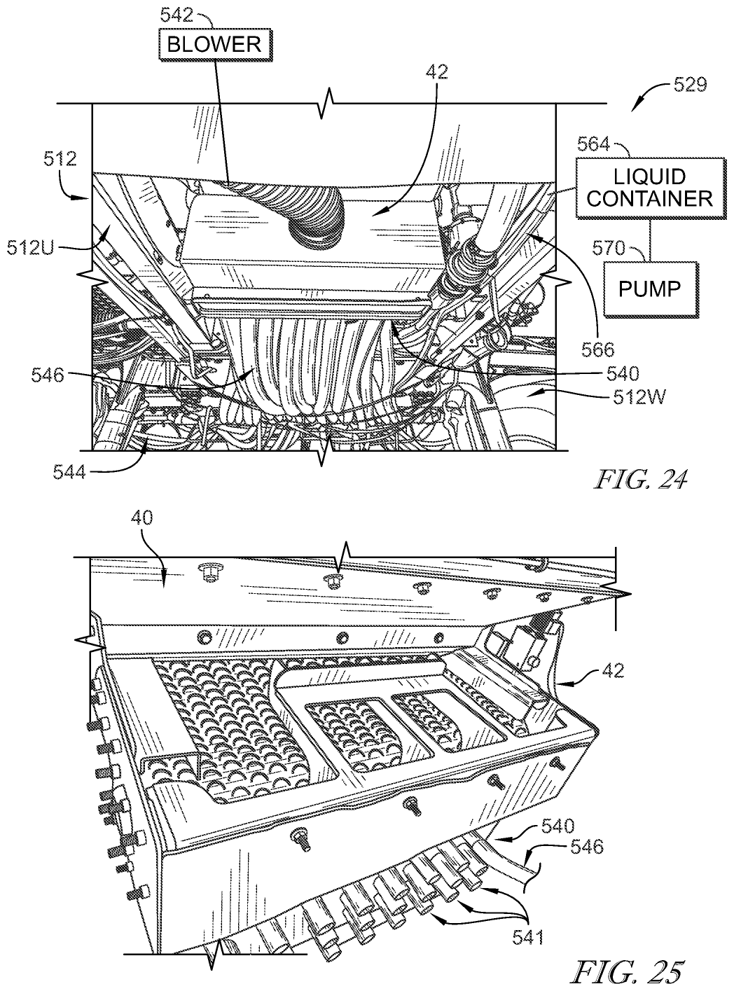

The diffusion system 526 includes a manifold 540, a blower 542, and a plurality of ducts 543 as shown in FIGS. 23-27. The manifold 540 is coupled to nutrient-metering unit 42 on an underbody 512U of the vehicle frame 512 beneath dry-bulk container 40 as shown in FIGS. 24 and 25. Dry-bulk nutrients fall onto the metering unit 42 and the metering unit 42 conveys the dry bulk nutrients to the manifold 540. The manifold 540 includes a plurality of outlet ports 541. The metering unit 42 is configured to deliver individual applications of dry-bulk nutrients to each outlet port 541. The blower 542 displaces each individual application of dry-bulk nutrients through each corresponding outlet port 541 toward a sprayer boom 544 of the vehicle 510.

The plurality of ducts 543 includes a plurality of conveyor ducts 546 that are coupled to the outlet ports 541 of the manifold 540 and a plurality of drop tubes 562 as shown in FIGS. 23-25. The conveyor ducts 546 extend forward from the manifold 540 between front wheels 512W of the vehicle 510 toward a front end of the vehicle 510 as shown in FIG. 24. Extending the conveyor ducts 546 forward between the front wheels 512W to the sprayer boom 544 increases visibility for an operator seated in a cabin 512C of the vehicle as shown in FIG. 23. With this arrangement, the operator is able to see clearly out of front and side windows of the cabin 512C. In some embodiments, the plurality of conveyor ducts 546 and the plurality of drop tubes 562 may be integral and extend uninterrupted from the manifold 540 to the root structures of the matured row crops.

The plurality of conveyor ducts 546 then disperse in both directions along a length of the sprayer boom 544 as shown in FIG. 23. Drop tubes 562 are coupled to each of the conveyor ducts 546 and extend downwardly from the sprayer boom 543 between rows of mature crops toward the roots of the mature crops as shown in FIG. 27. The drop ducts 562 are made from a rigid material so that a distal end 562D of each drop tube is maintained at the roots of the mature crops to deliver the dry-bulk nutrients directly to the roots during operation. The drop tubes 562 may have some resiliency to flex slightly when contacting the leaves of the crops so that the drop tubes 562 do not break during operation.

The liquid delivery system 529 includes a liquid container 564 that is separate from container 40, at least one liquid-conveyor duct 566, and a plurality of spray nozzles 568 coupled to the liquid-conveyor duct 566 as shown in FIGS. 24, 26, and 27. The liquid container 564 is coupled to the vehicle frame 512 and stores the crop-yield increasing liquid therein. The liquid-conveyor duct 566 is coupled to the liquid container 564 to receive a stream of the crop-yield increasing liquid from the liquid container 564. The liquid delivery system 529 may include a pump 570 to displace and pressurize the stream of the crop-yielding liquid from the liquid container 564.

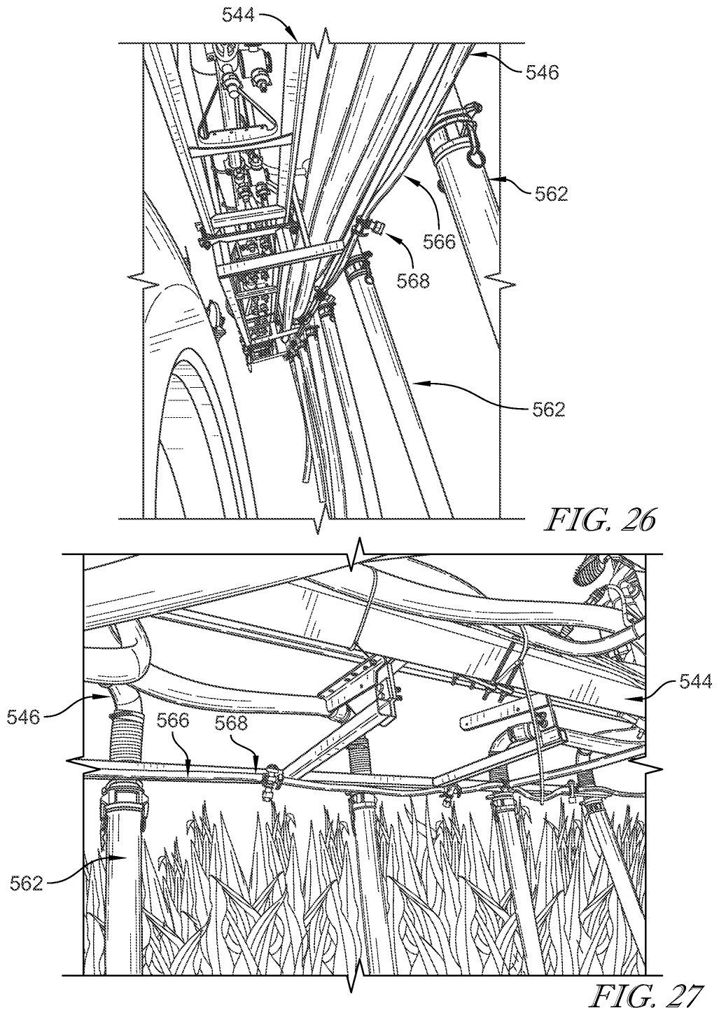

The liquid-conveyor duct 566 extends from the liquid container 564 to the sprayer boom 544 and extends along the sprayer boom 544 as shown in FIGS. 26 and 27. The plurality of spray nozzles 568 are spaced apart from one another along the sprayer boom 544 and point toward downwardly from the sprayer boom 544 toward underlying crops. The stream of crop-yield increasing liquid is ejected from the sprayer nozzles 568 to coat the leaves of the mature crops during operation. The distal end of the drop tubes 562 are arranged at the roots of the mature crops and the spray nozzles 568 are coupled to the sprayer boom 544 above the distal ends. This prevents the crop-yield increasing liquid from interfering with the dry-bulk nutrients.

There exist a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

1. A vehicle for distributing nutrients, comprising
a frame,
an engine coupled to the frame, and
a distribution system configured to distribute nutrients directly to the root structure of a mature row crop and a crop-yield increasing liquid to the leaves of the mature row crop, the distribution system including a dry-bulk nutrient delivery system and a liquid delivery system,
wherein the dry-bulk nutrient delivery system includes a nutrient release system and a diffusion system, the nutrient release system being configured to convey the nutrients from the vehicle to the diffusion system, a diffusion system coupled to the nutrient release system and configured to apply the nutrients directly on a root structure of the mature row crop, and
wherein the liquid delivery system includes a liquid container coupled to the vehicle, a liquid-conveyor duct coupled to the liquid container, and a plurality of spray nozzles coupled to the liquid-conveyor duct and configured to discharge the crop-yield increasing liquid onto the leaves of the mature row crop simultaneously with delivery of the dry-bulk nutrients to the root structure of the mature row crop.

2. The vehicle of claim 1, wherein the diffusion system includes a manifold coupled to a plenum and in fluid communication with a plurality of conveyor ducts, a boom coupled to the frame of the vehicle and configured to support the plurality of ducts, and a plurality of drop ducts coupled to the boom, each drop duct being in fluid communication with one of the plurality of conveyor ducts to deliver the nutrients from the manifold to each of the drop ducts.

3. The vehicle of claim 2, wherein the boom includes a support structure coupled to the frame for pivotable movement about an axis, a duct carriage coupled to the support structure, and a toolbar coupled to the support structure and configured to move upward and downward relative to the frame as the support structure pivots about the axis.

4. The vehicle of claim 3, wherein the duct carriage is coupled to the support structure for pivotable movement as the toolbar is moved upwardly and downwardly and includes a first duct carrier configured to receive a first set of ducts and a second carrier configured to receive a second set of ducts.

5. The vehicle of claim 4, wherein the each drop duct is coupled to a diffuser that includes a body, an outlet chamber coupled to the body, and an overflow chamber coupled to the body.

6. The vehicle of claim 5, wherein the outlet includes a first port extending from the body in a first direction and a second port extending from the body in a second direction opposite the first direction, the first port is configured to direct nutrients to a first row of plants and the second port is configured to direct nutrients to a second row of plants spaced apart from the first row of plants.

7. The vehicle of claim 6, wherein the overflow chamber includes a first overflow port extending from the body in the first direction and a second overflow port extending from the body in the second direction opposite the first direction.

8. The vehicle of claim 1, wherein the apparatus further includes a control system configured to vary an output of nutrients released at the root structure of the mature crops over a geographic area based on predetermined conditions.

9. The vehicle of claim 8, wherein the control system includes memory and a processor, the memory is configured to store data associated with the predetermined conditions and the processor is configured to send input signals to the nutrient release system to vary an output of nutrients over a specific geographic area based on the predetermined conditions.

10. The vehicle of claim 9, wherein the control system is configured to release a first output of nutrients over a first geographic area and is configured to release a second output of nutrients over a second geographic area based on the predetermined conditions.

11. The vehicle of claim 8, wherein the predetermined conditions include at least one of soil type, ground fertility, rain maps, nitrogen models, tile maps, and normalized difference vegetation index.

12. The vehicle of claim 11, wherein the control system is configured to compare historical conditions to the predetermined conditions to calibrate the output of nutrients.

13. A method comprising
providing a vehicle having a container of dry nutrients, a liquid container, and a boom coupled to the vehicle,
moving the vehicle through a field of row crops,
feeding an output of the dry nutrients from the container of dry nutrients into a manifold,
separating the output of the dry nutrients into row-wise deliveries,
conveying the row-wise deliveries from the manifold to the rows of crops,
spreading the row-wise deliveries along a length of the boom,
distributing the row-wise deliveries directly to root structures of the row crops, and
feeding a stream of crop-yield increasing liquid from the liquid container through a liquid-conveyor duct to a plurality of spray nozzles for discharge onto leaves of the row crops simultaneously with the step of distributing row-wise deliveries directly to root structures of the row crops.

14. The method of claim 13, further comprising metering the output of dry nutrients based on predetermined conditions associated with a geographic area.

15. The method of claim 14, wherein metering the output of dry nutrients includes adjusting a speed of the vehicle.

16. The method of claim 14, wherein metering the output of dry nutrients includes adjusting an outlet valve.

17. The method of claim 14, wherein metering the output of dry nutrients includes varying a feed system coupled between the container and the manifold.

18. The method of claim 13, further comprising diffusing a first row-wise delivery toward the root structure of a first row of crops and diffusing the first row-wise delivery toward the root structure of a second row of crops.

19. The method of claim 18, further comprising using a single arm to open the soil adjacent to a first row of crops to provide a first trench and diffusing the first row-wise delivery into the first trench, and to open the soil adjacent to a second row of crops to provide a second trench and diffusing the first row-wise delivery into the first and second trenches.

20. A vehicle for distributing nutrients, comprising
a frame,
a boom coupled to the frame, and
a distribution system configured to simultaneously distribute nutrients directly to a root structure of a mature row crop and a crop-yield increasing liquid to the leaves of the mature row crop.
